(19) United States
(12) Patent Application Publication
(10) Pub. No.: US 2019/0182368 A1
(43) Pub. Date: Jun. 13, 2019

(54) OT SYSTEM MONITORING METHOD, APPARATUS, AND SYSTEM, AND STORAGE MEDIUM

(71) Applicant: Siemens Aktiengesellschaft, Munich (DE)

(72) Inventor: Wen TANG, Beijing (CN)

(73) Assignee: Siemens Aktiengesellschaft, Munich (DE)

(21) Appl. No.: 16/059,208

(22) Filed: Aug. 9, 2018

(30) Foreign Application Priority Data
Dec. 13, 2017 (CN) 201711329002.5

(51) Int. Cl. H04L 29/06; H04L 12/24; G06F 9/54

(52) U.S. Cl. CPC H04L 69/22; G06F 9/54; H04L 41/12; H04L 69/26

(57) ABSTRACT

Embodiments relates to the field of industrial security technologies to improve visibility of an OT system, thereby effectively preventing a security risk. Embodiments provide an OT monitoring system, including: at least one network sensor to obtain at least one data packet transmitted in an OT system and send the at least one data packet to an OT monitoring apparatus; and the OT monitoring apparatus, to extract, from the obtained at least one data packet, information about at least one asset included in the OT system; and either provide a first application programming interface (API) according to the extracted information, where when the first API is invoked, an asset directory of the OT system is generated; or determine an asset directory of the OT system according to the extracted information. The asset directory of the OT system can improve visibility of the OT system, to more accurately locate the security risk.

### PRIORITY STATEMENT

The present application hereby claims priority under 35 U.S.C. § 119 to Chinese patent application number CN 201711329002.5 filed Dec. 13, 2017, the entire contents of which are hereby incorporated herein by reference.

### BACKGROUND

### Field

At least one embodiment of the present invention generally relates to the field of industrial security technologies, and in particular, to an operational technology (OT) system monitoring method, apparatus, and system, and a storage medium.

### Background

An OT system, which may also be referred to as an industrial control system (ICS) is used to implement automatic control in an industrial process. An OT system may be a wind power generation system, an automobile manufacturing workshop, a pharmaceutical factory, a wastewater treatment system for a city, or the like.

A conventional OT system uses a closed design, and it is very difficult for a network attack to threaten the OT system. However, with the development of automatic manufacturing and process control technologies, OT systems widely use an information technology (IT), and are no longer enclosed systems, but for current OT systems, there is a lack of a perfect security monitoring mechanism for discovering in time a security risk that the OT systems face.

### SUMMARY

Complexity and variability of an OT system increase a difficulty in security monitoring. However the inventors have discovered that performing effective security monitoring on a complex and dynamically changing OT system becomes a problem urgently needing to be resolved at present.

To better monitor an OT system and accurately locate a security risk, first, visibility of the OT system needs to be improved.

Embodiments of the present invention provide an OT system monitoring method, apparatus, and system, and a storage medium, so as to improve visibility of an OT system, thereby better monitoring the OT system, and effectively preventing a security risk.

According to a first embodiment, an OT monitoring method is provided. The method may be performed by an OT monitoring apparatus provided in an embodiment of the present invention. In the method, first, at least one data packet transmitted in an OT system is obtained; then, information about at least one asset included in the OT system is extracted from the obtained at least one data packet; and finally, an asset directory of the OT system is determined according to the extracted information about the at least one asset. The asset directory of the OT system can improve visibility of the OT system, so that a security risk is more accurately located. The asset of the OT system may include, but is not limited, to various devices, software, or programs in the OT system, for example, network devices such as an industrial controller, an industrial host, a router and a switch, and industrial software.

According to a second embodiment, an OT monitoring method is provided. The method may be performed by an OT monitoring apparatus provided in an embodiment of the present invention. In the method, first, at least one data packet transmitted in an OT system is obtained; then, information about at least one asset included in the OT system is extracted from the obtained at least one data packet; and finally, a first application programming interface (API) is provided according to the extracted information about the at least one asset, where the first API is configured to be invoked to generate an asset directory of the OT system. The asset directory of the OT system can improve visibility of the OT system, so that a security risk is more accurately located.

According to a third embodiment, an OT system monitoring method is provided. The method may be performed by an OT monitoring application apparatus provided in an embodiment of the present invention. In the method, at least one API is invoked; and the at least one API is invoked to implement at least one of the following monitoring items on an OT system: generating an asset directory of the OT system; determining a network topology of the OT system; determining an asset feature of at least one asset in the OT system; determining a change in the asset feature of the at least one asset in the OT system; and determining an operation for the OT system. In this way, for example, an asset directory, a network topology, an asset feature, and a change in the asset feature of an OT system, and an operation for the OT system can be conveniently obtained by invoking an API, so that visibility of the OT system can be improved, and a security risk can be more accurately located.

According to a fourth embodiment, an OT monitoring system is provided. The system may include: at least one network sensor, configured to: obtain at least one data packet transmitted in an OT system and send the at least one data packet to an OT monitoring apparatus; and the OT monitoring apparatus, configured to: obtain the at least one data packet from the at least one network sensor; extract, from the obtained at least one data packet, information about at least one asset included in the OT system; and provide a first API according to the extracted information about the at least one asset, where the first API is configured to be invoked to generate an asset directory of the OT system; or determine an asset directory of the OT system according to the extracted information about the at least one asset. The asset directory of the OT system can improve visibility of the OT system, so that a security risk is more accurately located.

According to a fifth embodiment, an OT monitoring apparatus is provided. The apparatus may be configured to perform the method according to any one of the first embodiment or possible implementations of the first embodiment. A data obtaining module in the apparatus may be configured to obtain at least one data packet transmitted in an OT system. An information extraction module in the apparatus may be configured to extract, from the at least one data packet obtained by the data obtaining module, information about at least one asset (which may include network information of the asset, asset description information of the asset, and the like) included in the OT system, and the information extraction module may further extract a network connection relationship of the at least one asset, information about a subnet to which the asset belongs, communication information of the at least one asset, operation information for the asset, and the like. A monitoring module in the apparatus is configured to determine an asset directory of the OT system according to the information about the at least one asset extracted by the information extraction module, may be further configured to generate a network topology of the OT system, where optionally, the network topology may include the information about the subnet to which the asset belongs, and may be further configured to determine an asset feature of the asset, a change in the asset feature, and an operation for the OT system. Alternatively, the monitoring module in the apparatus is configured to provide a first API according to the information about the at least one asset extracted by the information extraction module, where the first API is configured to be invoked to generate an asset directory of the OT system, generate a network topology of the OT system, determine an asset feature of the asset and a change in the asset feature, determine an operation for the OT system, and the like.

According to a sixth embodiment, an OT monitoring application apparatus is provided, including an API invoking module, configured to invoke at least one API; and an application implementation module, configured to invoke the at least one API to implement at least one of the following monitoring items on an OT system: generating an asset directory of the OT system; determining a network topology of the OT system; determining a logical relationship of at least one asset in the OT system; determining a change in an asset feature of the at least one asset in the OT system; and determining an operation for the OT system. The asset directory of the OT system can improve visibility of the OT system, so that a security risk is more accurately located. The network topology of the OT system is determined, so that when a security risk occurs in the OT system, the risk can be more accurately located. The asset feature of the asset and the change in the asset feature are determined, so that an asset change in the OT system and a security risk that may exist can be discovered in time. The operation for the OT system is determined, so that a dangerous operation for the OT system can be discovered in time.

According to a seventh embodiment, an OT monitoring apparatus is provided, including: at least one memory, configured to store machine readable instructions; and at least one processor, configured to invoke the machine readable instructions stored in the at least one memory, to perform the method according to any one of the first embodiment or possible implementations of first embodiment, or the method according to any one of the second embodiment or possible implementations of the second embodiment.

According to an eighth embodiment, an OT monitoring application apparatus is provided, including: at least one memory, configured to store machine readable instructions; and at least one processor, configured to invoke the machine readable instructions stored in the at least one memory, to perform the method according to the third embodiment.

According to a ninth embodiment, a machine readable medium is provided, storing machine readable instructions, where when the machine readable instructions are invoked by at least one processor, the method according to any one of the first embodiment or possible implementations of the first embodiment, the method according to any one of the second embodiment or possible implementations of the second embodiment, or the method according to the third embodiment is performed.

### BRIEF DESCRIPTION OF THE DRAWINGS

FIG. 1 is a schematic diagram of an OT system;

FIG. 2 is a schematic diagram of an OT monitoring system according to an embodiment of the present invention;

FIG. 3 is a schematic structural diagram of a protocol stack of an OT monitoring system according to an embodiment of the present invention;

FIG. 4 is a flowchart of an OT monitoring method according to an embodiment of the present invention;

FIG. 5 is a schematic structural diagram of an OT monitoring apparatus according to an embodiment of the present invention;

FIG. 6 is a schematic structural diagram of another OT monitoring apparatus according to an embodiment of the present invention;

FIG. 7 is a schematic structural diagram of an OT monitoring application apparatus according to an embodiment of the present invention; and

FIG. 8 is another schematic structural diagram of an OT monitoring application apparatus according to an embodiment of the present invention.

### LIST OF REFERENCE NUMERALS

| | | |
|---|---|---|
| 10: OT system | 100: Subnet of the OT | 101: Asset |
| | system 10 | |
| 1011: Controller | 1012: Industrial host | 1013: Router or switch |
| 11: OT monitoring system | 111: Network sensor | 112: OT monitoring |
| | | apparatus |

| 20: At least one data packet transmitted | | 30: Information extracted from the at least |
|---|---|---|
| in the OT system 10 | | one data packet 20 |
| 301: Information about the asset in the | | 302: Network connection relationship of |
| OT system 10 | | assets in the OT system 10 |
| 303: Communication information of the | | 304: Operation information for the asset in |
| assets in the OT system 10 | | the OT system 10 |
| 401: Asset | 402: Network topology of | 4031: Asset feature of the asset in the OT |
| directory | the OT system 10 | system 10 |

| 4032: Change in the OT | 404: Operation for the OT | |
|---|---|---|
| system 10 | system 10 | |
| 50: OT monitoring system | 501: Data obtaining layer | 502: Data preparation layer |
| 5021: Data filtering | 5022: Information | 5023a: Deep packet |
| module | extraction module | analytics (DPA) Link Layer |
| | | Discovery Protocol (LLDP) |
| | | plug-in |
| 5023b: DPA PN-DCP | 5023c: DPA S7Comm | 5023d: Another DPA |
| plug-in | plug-in | plug-in |
| 503: Data storage layer | 504: API | 505: Application |
| 5051: Asset directory | 5052: Network topology | 5053: Change monitoring |
| generation application | discovery application | application |
| 5054: Operation | | |
| monitoring application | | |

S401: A network sensor 111 captures at least one data packet 20 transmitted in an OT
system 10
S402: The network sensor 111 sends the captured data packet 20 to an OT monitoring
apparatus 112
S403: The OT monitoring apparatus 112 performs data cleansing for the captured data
packet 20
S404: The OT monitoring apparatus 112 marks an identifier of the network sensor 111
for the data packet 20
S405: The OT monitoring apparatus 112 extracts information 30 from the data packet
20
S4051: The OT monitoring apparatus 112 classifies the captured data packet 20
according to an industrial protocol
S4052: The OT monitoring apparatus 112 performs DPA on the classified data packet
20
S406: The OT monitoring apparatus 112 stores the extracted information 30 in a
database
S407: The OT monitoring apparatus 112 provides the information 30 to an application
505 by using an API
S408: The application 505 invokes the API to implement a monitoring function and
present a monitoring result

| | | |
|---|---|---|
| 1121: Data obtaining | 1122: Information | 1123: Monitoring module |
| module | extraction module | |
| 1124: At least one memory | 1125: At least one | 1126: Display |
| | processor | |
| 12: OT monitoring | 121: API Invoking module | 122: Application |
| application apparatus | | implementation module |
| 123: At least one memory | 124: At least one processor | 125: Display |

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

According to a first embodiment, an OT monitoring method is provided. The method may be performed by an OT monitoring apparatus provided in an embodiment of the present invention. In the method, first, at least one data packet transmitted in an OT system is obtained; then, information about at least one asset included in the OT system is extracted from the obtained at least one data packet; and finally, an asset directory of the OT system is determined according to the extracted information about the at least one asset. The asset directory of the OT system can improve visibility of the OT system, so that a security risk is more accurately located. The asset of the OT system may include, but is not limited, to various devices, software, or programs in the OT system, for example, network devices such as an industrial controller, an industrial host, a router and a switch, and industrial software.

Optionally, network information of the at least one asset is extracted from a transport layer header of the obtained at least one data packet, and it is determined that the asset directory includes the network information of the at least one asset. In this way, the asset directory includes the network information of the asset, to facilitate locating of a security risk in a network.

Optionally, the obtained at least one data packet is classified according to an industrial protocol; and for each industrial protocol used for classification, asset description information of an involved asset is extracted from a data payload of the industrial protocol in a data packet using the industrial protocol; and it is determined that the asset directory includes asset description information of the at least one asset. The data packet is classified according to the industrial protocol; an in-depth analysis may be performed on a data payload of an industrial protocol in the data packet, to obtain the asset description information of the asset; and the asset description information is placed in the asset directory, so that the visibility of the OT system can be further improved.

Optionally, a network connection relationship of the at least one asset included in the OT system may be further determined according to the obtained at least one data packet; and a network topology of the OT system is determined according to the determined network connection relationship of the at least one asset. In this way, a solution for obtaining the network topology of the OT system is provided.

Further, for each of at least one subnet of the OT system, a data packet in the subnet is obtained; an asset included in the subnet is determined according to the data packet obtained from each of the at least one subnet; and further, it is determined that the network topology of the OT system includes information about the at least one subnet. The information about the subnet is included in the network topology, so that a locating range can be further narrowed down when a network risk occurs.

Optionally, there is a plurality of assets, and in the method, communication information of the at least one asset may be further extracted from the obtained at least one data packet; and an asset feature of the at least one asset is determined according to the determined communication information of the at least one asset, and a change in the asset feature of the at least one asset in the OT system is determined according to the determined communication information of the at least one asset. In this way, a change in the OT system can be monitored, to facilitate rapid discovery of an abnormality that may exist in the OT system.

Optionally, in the method, the obtained at least one data packet may be further classified according to an industrial protocol; and for each industrial protocol used for classification, operation information for an involved asset is extracted from a data payload of the industrial protocol in a data packet using the industrial protocol; and an operation for the OT system is determined according to the extracted operation information. In this way, the operation for the OT system can be monitored, and an abnormal operation for the OT system can be discovered in time.

According to a second embodiment, an OT monitoring method is provided. The method may be performed by an OT monitoring apparatus provided in an embodiment of the present invention. In the method, first, at least one data packet transmitted in an OT system is obtained; then, information about at least one asset included in the OT system is extracted from the obtained at least one data packet; and finally, a first application programming interface (API) is provided according to the extracted information about the at least one asset, where the first API is configured to be invoked to generate an asset directory of the OT system. The asset directory of the OT system can improve visibility of the OT system, so that a security risk is more accurately located.

Optionally, network information of the at least one asset is extracted from a transport layer header of the obtained at least one data packet; and the first API is provided, so that when the first API is invoked, information about an asset in the generated asset directory of the OT system includes network information of the asset. In this way, the asset directory includes the network information of the asset, to facilitate locating of a security risk in a network.

Optionally, the obtained at least one data packet is classified according to an industrial protocol; and for each industrial protocol used for classification, asset description information of an involved asset is extracted from a data payload of the industrial protocol in a data packet using the industrial protocol; and the first API is provided, so that when the first API is invoked, information about an asset in the generated asset directory of the OT system includes asset description information of the asset. The data packet is classified according to the industrial protocol; an in-depth analysis may be performed on a data payload of an industrial protocol in the data packet, to obtain the asset description information of the asset; and the asset description information is placed in the asset directory, so that the visibility of the OT system can be further improved.

Optionally, a network connection relationship of the at least one asset included in the OT system may be further determined according to the obtained at least one data packet; and a second API is provided according to the determined network connection relationship of the at least one asset, where the second API is configured to be invoked to generate a network topology of the OT system. In this way, a solution for obtaining the network topology of the OT system is provided.

Further, for each of at least one subnet of the OT system, a data packet in the subnet is obtained; an asset included in the subnet is determined according to the data packet obtained from each of the at least one subnet; and further, the second API is provided, so that when the second API is invoked, the generated network topology of the OT system includes information about the at least one subnet. The information about the subnet is included in the network topology, so that a locating range can be further narrowed down when a network risk occurs.

Optionally, there is a plurality of assets, and in the method, communication information of the at least one asset may be further extracted from the obtained at least one data packet; and a third API is provided according to the determined communication information of the at least one asset, where the third API is configured to be invoked to determine an asset feature of the at least one asset in the OT system, and the third API is further configured to be invoked to determine a change that the OT system violates the determined asset feature of the at least one asset. In this way, a change in the OT system can be monitored, to facilitate rapid discovery of an abnormality that may exist in the OT system.

Optionally, in the method, the obtained at least one data packet may be further classified according to an industrial protocol; and for each industrial protocol used for classification, operation information for an involved asset is extracted from a data payload of the industrial protocol in a data packet using the industrial protocol; and a fourth API is provided according to the extracted operation information, where the fourth API is configured to be invoked to determine an operation for the OT system. In this way, the operation for the OT system can be monitored, and an abnormal operation for the OT system can be discovered in time.

According to a third embodiment, an OT system monitoring method is provided. The method may be performed by an OT monitoring application apparatus provided in an embodiment of the present invention. In the method, at least one API is invoked; and the at least one API is invoked to implement at least one of the following monitoring items on an OT system: generating an asset directory of the OT system; determining a network topology of the OT system; determining an asset feature of at least one asset in the OT system; determining a change in the asset feature of the at least one asset in the OT system; and determining an operation for the OT system. In this way, for example, an asset directory, a network topology, an asset feature, and a change in the asset feature of an OT system, and an operation for the OT system can be conveniently obtained by invoking an API, so that visibility of the OT system can be improved, and a security risk can be more accurately located.

According to a fourth embodiment, an OT monitoring system is provided. The system may include: at least one network sensor, configured to: obtain at least one data packet transmitted in an OT system and send the at least one data packet to an OT monitoring apparatus; and the OT monitoring apparatus, configured to: obtain the at least one data packet from the at least one network sensor; extract, from the obtained at least one data packet, information about at least one asset included in the OT system; and provide a first API according to the extracted information about the at least one asset, where the first API is configured to be invoked to generate an asset directory of the OT system; or determine an asset directory of the OT system according to the extracted information about the at least one asset. The asset directory of the OT system can improve visibility of the OT system, so that a security risk is more accurately located.

Optionally, network information of the asset may be obtained from a transport layer header of the captured data packet; and the captured data packet is classified according to an industrial protocol, and asset description information is obtained from a data payload of the industrial protocol. The network information and the asset description information are provided in the asset directory of the OT system, so that visibility of the OT system can be further improved.

Optionally, a network topology of the OT system may be further determined; a subnet to which an asset belongs may be determined by identifying a subnet identifier for network traffic; and a subnet to which an asset belongs is identified in the network topology of the OT system, so that when a security risk occurs in the OT system, the risk can be more accurately located.

Optionally, an asset feature of the asset may be further determined according to communication information of assets, to determine a change in the OT system according to the communication information, and discover, in time, a change in the asset feature of the OT system and a security risk that may exist.

Optionally, by way of the embodiments of the present invention, the captured data packet may be further classified according to an industrial protocol; and for different industrial protocols, operation information for the asset is extracted from a data payload of the industrial protocol, to determine an operation for the OT system. A dangerous operation for the OT system can be discovered in time.

According to a fifth embodiment, an OT monitoring apparatus is provided. The apparatus may be configured to perform the method according to any one of the first embodiment or possible implementations of the first embodiment. A data obtaining module in the apparatus may be configured to obtain at least one data packet transmitted in an OT system. An information extraction module in the apparatus may be configured to extract, from the at least one data packet obtained by the data obtaining module, information about at least one asset (which may include network information of the asset, asset description information of the asset, and the like) included in the OT system, and the information extraction module may further extract a network connection relationship of the at least one asset, information about a subnet to which the asset belongs, communication information of the at least one asset, operation information for the asset, and the like. A monitoring module in the apparatus is configured to determine an asset directory of the OT system according to the information about the at least one asset extracted by the information extraction module, may be further configured to generate a network topology of the OT system, where optionally, the network topology may include the information about the subnet to which the asset belongs, and may be further configured to determine an asset feature of the asset, a change in the asset feature, and an operation for the OT system. Alternatively, the monitoring module in the apparatus is configured to provide a first API according to the information about the at least one asset extracted by the information extraction module, where the first API is configured to be invoked to generate an asset directory of the OT system, generate a network topology of the OT system, determine an asset feature of the asset and a change in the asset feature, determine an operation for the OT system, and the like.

The asset directory of the OT system can improve visibility of the OT system, so that a security risk is more accurately located. The network information and the asset description information are provided in the asset directory of the OT system, so that visibility of the OT system can be further improved. The network topology of the OT system is determined and the subnet to which the asset belongs is identified in the network topology, so that when a security risk occurs in the OT system, the risk can be more accurately located. A change in the OT system is determined according to the communication information of assets, so that an asset change in the OT system and a security risk that may exist can be discovered in time. The captured data packet is classified according to an industrial protocol; and for different industrial protocols, operation information for the asset is extracted from a data payload of the industrial protocol, to determine an operation for the OT system, so that a dangerous operation for the OT system can be discovered in time.

According to a sixth embodiment, an OT monitoring application apparatus is provided, including an API invoking module, configured to invoke at least one API; and an application implementation module, configured to invoke the at least one API to implement at least one of the following monitoring items on an OT system: generating an asset directory of the OT system; determining a network topology of the OT system; determining a logical relationship of at least one asset in the OT system; determining a change in an asset feature of the at least one asset in the OT system; and determining an operation for the OT system. The asset directory of the OT system can improve visibility of the OT system, so that a security risk is more accurately located. The network topology of the OT system is determined, so that when a security risk occurs in the OT system, the risk can be more accurately located. The asset feature of the asset and the change in the asset feature are determined, so that an asset change in the OT system and a security risk that may exist can be discovered in time. The operation for the OT system is determined, so that a dangerous operation for the OT system can be discovered in time.

According to a seventh embodiment, an OT monitoring apparatus is provided, including: at least one memory, configured to store machine readable instructions; and at least one processor, configured to invoke the machine readable instructions stored in the at least one memory, to perform the method according to any one of the first embodiment or possible implementations of first embodiment, or the method according to any one of the second embodiment or possible implementations of the second embodiment.

According to an eighth embodiment, an OT monitoring application apparatus is provided, including: at least one memory, configured to store machine readable instructions; and at least one processor, configured to invoke the machine readable instructions stored in the at least one memory, to perform the method according to the third embodiment.

According to a ninth embodiment, a machine readable medium is provided, storing machine readable instructions, where when the machine readable instructions are invoked by at least one processor, the method according to any one of the first embodiment or possible implementations of the first embodiment, the method according to any one of the second embodiment or possible implementations of the second embodiment, or the method according to the third embodiment is performed.

As described above, complexity and variability of an OT system increase a difficulty in performing security monitoring on the OT system. In embodiments of the present invention, visibility of an OT system is improved, to improve a monitoring result of the OT system, thereby effectively preventing a security risk. An OT monitoring system captures a data packet transmitted in the OT system, extracts, from the captured data packet, information about at least one asset included in the OT system, and further determines an asset directory of the OT system according to the extracted information about the at least one asset. The asset directory of the OT system can improve visibility of the OT system, so that a security risk is more accurately located.

Network information of the asset may be obtained from a transport layer header of the captured data packet. The captured data packet is classified according to an industrial protocol, and asset description information is obtained from a data payload of the industrial protocol. The network information and the asset description information are provided in the asset directory of the OT system, so that visibility of the OT system can be further improved.

In addition, by way of the embodiments of the present invention, a network topology of the OT system may be further determined; a subnet to which an asset belongs may be determined by identifying a subnet identifier for network traffic; and a subnet to which an asset belongs is identified in the network topology of the OT system, so that when a security risk occurs in the OT system, the risk can be more accurately located.

In addition, by way of the embodiments of the present invention, an asset feature of the asset may be further determined according to communication information of assets, to determine a change in the asset feature of the OT system according to the communication information, and discover, in time, a change in the asset of the OT system and a security risk that may exist.

In addition, by way of the embodiments of the present invention, the captured data packet may be further classified according to an industrial protocol; and for different industrial protocols, operation information for the asset is extracted from a data payload of the industrial protocol, to determine an operation for the OT system. A dangerous operation for the OT system can be discovered in time.

To make the present invention easier to be understood, an OT system and some descriptions in the embodiments of the present invention are explained below. It should be noted that, these explanations should not be construed as a limitation to the protection scope of the present invention.

### 1. OT System

In an OT, a physical device in an enterprise, a process, and an event are directly monitored and/or controlled by using hardware and software, to implement detection or control. In an OT system, a computer is used to monitor or change a physical state of a system. Examples of the OT system include: a supervisory control and data acquisition (SCADA) system, a distributed control system (DCS), a computer numerical control (CNC) system (including a computerized mechanical tool), and a scientific device (for example, a digital oscilloscope).

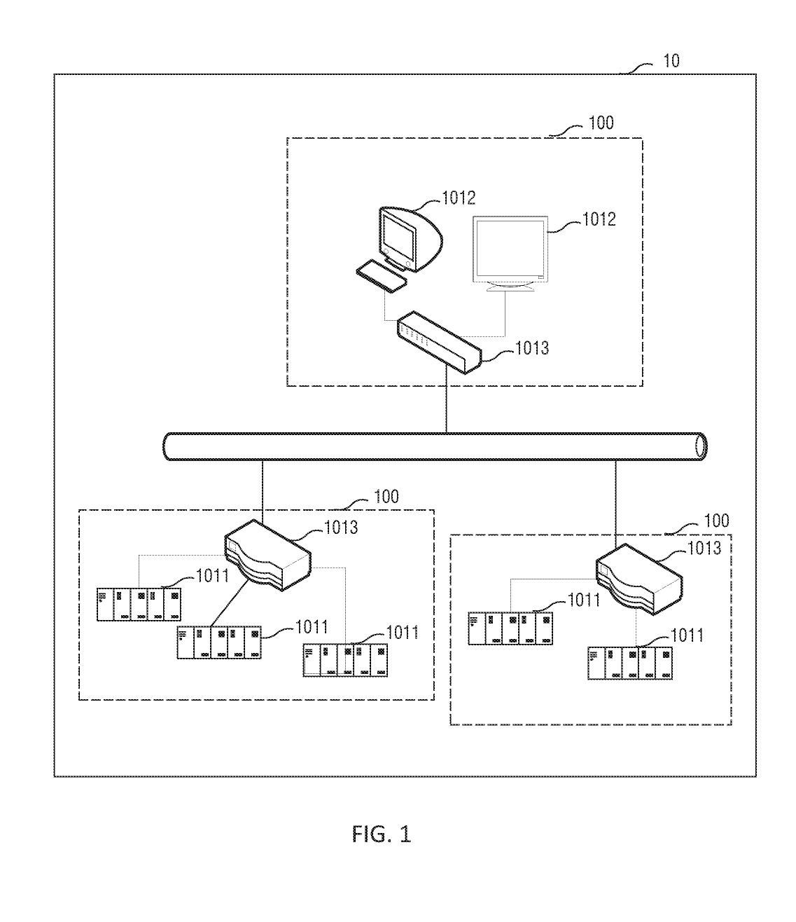

FIG. 1 is a schematic diagram of an OT system 10. As shown in FIG. 1, the OT system 10 may include, but is not limited to, the following devices: 1) at least one industrial controller 1011, 2) at least one industrial host 1012, and 3) at least one network device 1013.

1) The at Least One Industrial Controller 1011

An industrial controller 1011 may be a programmable logical controller (PLC), a DCS controller, an RTU, or the like.

2) The at Least One Industrial Host 1012

The industrial host 1012 may include a host computer such as a workstation or a server implemented based on a personal computer (PC), for example, an engineer station, an operator station, or a server. The industrial host 1012 may further include a human machine interface (HMI). In an ICS, an industrial host monitors and controls the industrial controller 1011 by using the industrial Ethernet, for example, controls the industrial controller 1011 to read data from a field device (for example, read a status parameter of the field device from a sensor), stores the data in a historical database, sends a control command to the industrial controller 1011 according to an instruction of an operator or according to a preset control program or preset logic, and the like. The engineer station may also configure the industrial controller 1011.

3) The at Least One Network Device 1013

The network device 1013 forms an industrial control network, to connect to each industrial controller 1011 and each industrial host 1012. Currently, a growing quantity of industrial control networks are implemented based on the industrial Ethernet, and communication in the industrial Ethernet may be based on the Transmission Control Protocol (TCP), the User Datagram Protocol (UDP), the Internet Protocol (IP) or the like. The network device 1013 may include, but is not limited to, a router, a switch, or the like.

The devices included in the OT system 10, for example, the industrial controller 1011, the industrial host 1012, and the network device 1013, may also be referred to as assets in the OT system 10. In addition, assets may further include some software, programs, and the like run in the OT system 10. Some assets may belong to a same subnet 100, as shown in FIG. 1.

### 2. Network Monitoring

Network monitoring methods or tools may include, but are not limited to, the following two types: active network monitoring and passive network monitoring. In active network monitoring, detection network traffic is sent to a network, and a feedback of the network is measured or monitored. Active network monitoring is like a controlled experiment, and is applicable to obtaining data specific to network performance. In passive network monitoring, only network traffic that is already transmitted in a network is monitored, and a network packet is captured by using a device connected to the network, for an analysis.

In the embodiments of the present invention, a network sensor may be deployed to capture network traffic of an OT system, and perform passive network monitoring on the OT system; and running of the OT system is not affected.

### 3. Network Traffic Capture

Network traffic capture, or referred to as packet capture, is used to obtain a data packet transmitted in a specific network, and a computer program or hardware may be used to translate and record network traffic transmitted in a network or a part of a network. A packet is captured when the packet is transmitted in a network, original data of the packet is decoded as required, and values of different fields in the packet are provided and content of the packet is analyzed. The captured network traffic may include at least one of the following traffic: a data packet transmitted between devices in the network, a data packet entering the network from an external device, and a data packet transmitted from the network to the outside.

For a wired broadcast local area network such as the Ethernet, a token ring network, or a fiber distributed data interface (FDDI) network, depending on a network structure (based on a switch or based on a hub), a separate device may be used to capture all or some of network traffic in the network. A method for deploying a capture device in a network includes, but is not limited to: connecting the capture device to a switched port analyzer (SPAN) port of a switch or a router in the network for performing port mirroring, so that all packets passing through all ports of the switch can be captured. Alternatively, a network tap is used. In this way, the network traffic flows to the network tap from the network. For a wireless local area network, network traffic may be captured on a specific channel, or multiple adapters are used to capture network traffic on several channels.

In some embodiments of the present invention, when network traffic is captured, an entire packet (including a data payload) of a data packet in the network traffic may be captured. An advantage is that, all Ethernet or IP activity information can be extracted from the data packet, for network forensics or a network security analysis. The entire packet of the data packet in the network traffic is captured, to avoid that a data packet cannot be re-obtained due to missing of the data packet. This is more important to a case in which a network behavior cannot be predicted. For example, a network administrator generally does not know a feature and an operation manner of an advanced persistent threat (APT). Consequently, occurrence of an APT cannot be predicted. The entire packet of the data packet transmitted in the network is captured, and further a data analysis is performed, so that missing of information can be avoided, and a feature of the APT can be accurately obtained, to perform risk evaluation and prediction, thereby effectively preventing a network security threat.

In the embodiments of the present invention, a passive network monitoring manner may be used to capture a large quantity of data packets (including a packet header and a data payload) transmitted in an OT system, and extract a large quantity of information from the captured data packets. For example, information is obtained from a TCP header to determine a network topology of the OT system, and identify a service and an operating system run in a network device, and a potential malicious act.

An OT system is relatively vulnerable to a network attack due to an inadequate security risk prevention capability and a relatively long running time. In the embodiments of the present invention, a data packet transmitted in an OT system may be captured, the OT system may be monitored by running various applications, an asset directory of the OT system may be established, a network topology may be discovered, and a change in the system, a network behavior, and an operation for the OT system may be monitored, so that visibility of the OT system can be effectively improved. The passive network monitoring manner may be used to avoid affecting running of the OT system when an additional data packet is input to the OT system.

The following describes the embodiments of the present invention in detail with reference to the accompanying drawings.

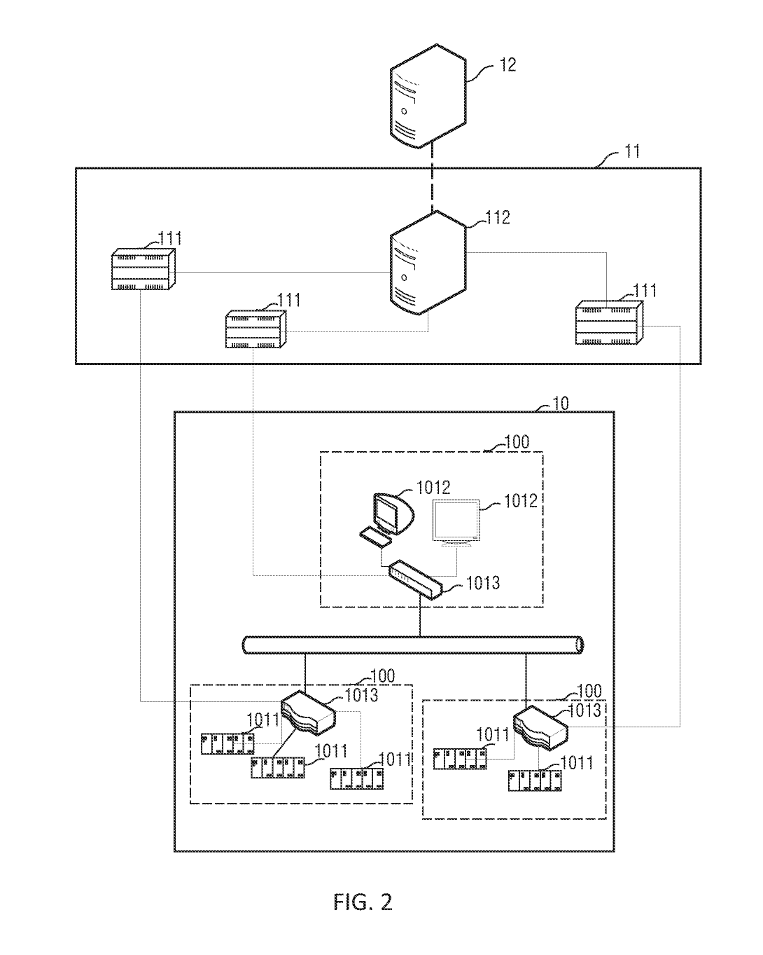

FIG. 2 is a schematic diagram of an OT monitoring system 11 according to an embodiment of the present invention. As shown in FIG. 2, the OT monitoring system 11 may include at least one network sensor 111, and an OT monitoring apparatus 112.

The at least one network sensor 111 may be deployed in each subnet of an OT system 10, and obtain at least one data packet 20 transmitted in the OT system 10. Optionally, the network sensor 111 may obtain all data packets 20 transmitted in the OT system 10, to completely and accurately monitor the OT system 10. The network sensor 111 may organize the received at least one data packet 20 into PCAP data and send the PCAP data to an OT monitoring apparatus 112. In an embodiment of the present invention, the network sensor 111 may obtain the data packet 20 by using a passive network monitoring manner, for example, by performing port mirroring by using a SPAN, or by using a network tap. Use of the network sensor 111 provides a dedicated data packet capture solution applicable to an industrial environment and having low costs, which may be used to capture data packets 20 in different subnets of the OT system 10. A hardware structure of the network sensor 111 may include two network interfaces, where one network interface is configured to capture the data packet 20 from the OT system 10, and the other network interface is configured to forward the captured data packet 20 to the OT monitoring apparatus 112. Use of the two network interfaces can avoid that forwarding of the data packet 20 occupies network bandwidth of the OT system 10, and avoid affecting production and running of the OT system 10.

The OT monitoring apparatus 112 is configured to: receive the data packet 20 from the network sensor 111, and prepare and analyze data. The OT monitoring apparatus 112 may provide a service to each network sensor 111, so that the network sensor 111 uploads data packets 20 captured from different subnets of the OT system 10. In an optional implementation, the OT monitoring apparatus 112 extracts information 30 about the OT monitoring system 11 from the data packet 20, and provides an API externally based on the information 30, to be invoked by a third-party application 12 to monitor the OT system 10. In another optional implementation, the OT monitoring apparatus 112 monitors the OT system 10 based on the information.

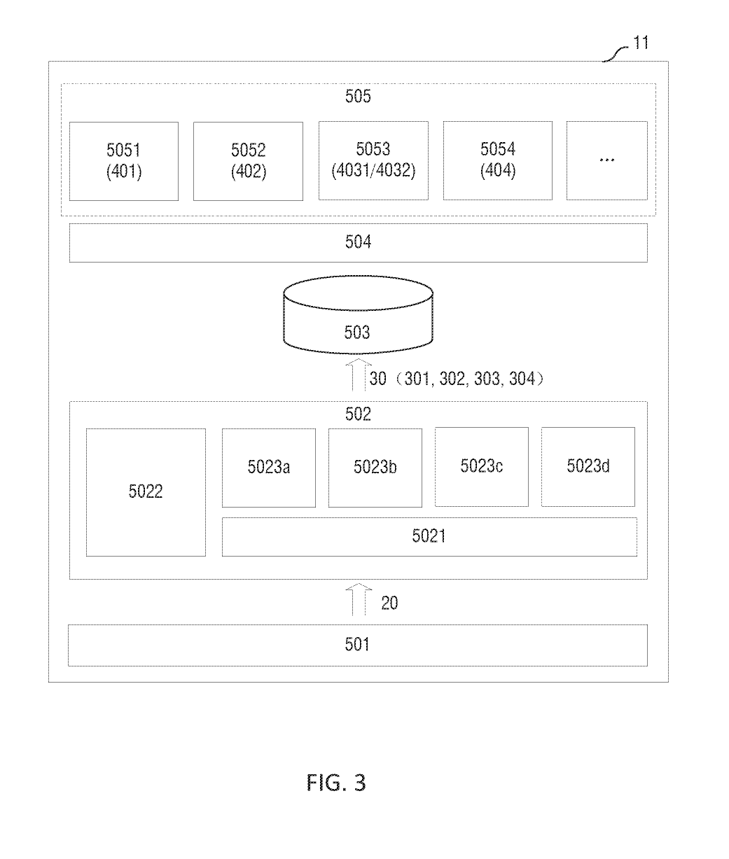

FIG. 3 is a schematic structural diagram of an optional protocol stack of an OT monitoring system 10 according to an embodiment of the present invention. As shown in FIG. 3, the protocol stack may include the following five layers: a data obtaining layer 501, a data preparation layer 502, a data storage layer 503, an API 504, and an application 505.

The Data Obtaining Layer 501

The layer is configured to obtain a data packet 20 transmitted in the OT system 10.

The layer may include a convergence function in a network sensor 111 and an OT monitoring apparatus 112, and is configured to converge data packets 20 in a PCAP format from different network sensors 111. The data obtaining layer 501 may further obtain a data packet 20 from each subnet 100 of the OT system 10, combine the data packets 20 together, and perform data cleansing, for example, remove redundant data packets 20 captured by different network sensors 111, and mark an identifier of the network sensor 111 for the data packet 20, for next-step processing.

The Data Preparation Layer 502

The layer mainly includes the following several parts: 1) a data filtering module 5021, 2) an information extraction module 5022, and 3) a DPA plug-in.

1) The Data Filtering Module 5021

The module is configured to classify original data packets 20 into different packet sequences according to protocols, and data packets 20 of a same protocol or a similar protocol are classified into one sequence. For example, all data packets 20 using the LLDP are classified into one sequence, and all data packets using the S7Comm are classified into another sequence.

2) The Information Extraction Module 5022

The module may be configured to obtain information about a general IT protocol from a frame or a packet of the data packet 20, for example, obtain the following information from a Medium Access Control (MAC)/IP/TCP/UDP header of the data packet 20: a MAC address, an IP address, a TCP/UDP port number, or a TCP flag.

The module may further derive a network connection relationship 302 of assets in the OT system 10 based on deployment of the network sensor 111. For example, data packets 20 from a same network sensor 111 may come from a same router or switch 1013, that is, come from a same subnet.

The module may further monitor a network behavior of the OT system 10 based on knowledge of a network protocol. For example, when a TCP packet passes through a router, the router decreases a value of a TTL field by 1. Therefore, when the module monitors a phenomenon that the value of the TTL field is decreased by 1, it may be determined that the TCP packet passes through a router rather than a switch.

The module may further perform further derivation based on basic knowledge of a network. For example, if assets 101 in a group all have a prefix such as 192.168.0.*, it may be determined that an address of a subnet to which the assets 101 in the group belong may be 192.168.0.0/24.

3) The DPA Plug-in

The DPA plug-in is configured to extract information from a data payload of a data packet 20 of a specified protocol, and may be further configured to associate various extracted information, to generate valuable information for the OT system 10. The DPA plug-in may be classified, according to a protocol part processed by the DPA plug-in, into: a DPA LLDP plug-in 5023a, a DPA PN-DCP plug-in 5023b, a DPA S7Comm plug-in 5023c, or another DPA 5023d plug-in (configured to process another protocol). The information obtained by the DPA plug-in includes, but is not limited to, information 301 about the asset, for example, an asset name, a hardware version or a firmware version. The DPA plug-in may extract the information from data payloads of various industrial protocols such as the LLDP and the PROFINET-DCP, and extract communication information 303 of the assets in the OT system 10, and operation information 304 for the asset in the OT system 10.

The Data Storage Layer 503

The data storage layer 503 is configured to store information 30 prepared by the data preparation layer 502, which may include the information 301 about the asset in the OT system 10, the network connection relationship 302 of the assets in the OT system 10, the communication information 303 of the assets in the OT system 10, and the operation information 304 for the asset in the OT system 10. An information storage form includes, but is not limited to, storage in a database, storage in a file, or buffering.

API 504

APIs are provided to different applications 505 based on the various information 30 stored in the data storage layer 503.

The Application 505

The information 30 about the OT system 10 is obtained by invoking the API, and an implementable application 505 includes, but is not limited to:

1) an asset directory generation application 5051 (generating an asset directory 401);

2) a network topology discovery application 5052 (determining a network topology 402 of the OT system 10);

3) a change monitoring application 5053 (determining an asset feature 4031 of the asset in the OT system 10 and a change in the OT system 10); and

4) an operation monitoring application 5054 (determining an operation for the OT system 10).

In addition, a network load monitoring application, a network behavior monitoring application, an industrial application monitoring application, a threat monitoring application, and the like may be further included.

In an optional implementation, in the foregoing structure of the protocol stack, the OT monitoring apparatus 112 implements a data cleansing function and the like of the data obtaining layer 501 (as described above), a function of the data preparation layer 502, a function of the data storage layer 503, and a function of the API 504, to provide the API externally. However, the application 505 is developed and implemented by another third-party device. In another optional implementation, the OT monitoring apparatus 112 provides no API, but implements various applications 505 by itself. For such a manner, the application 505 may be considered as a part of the OT monitoring apparatus 112.

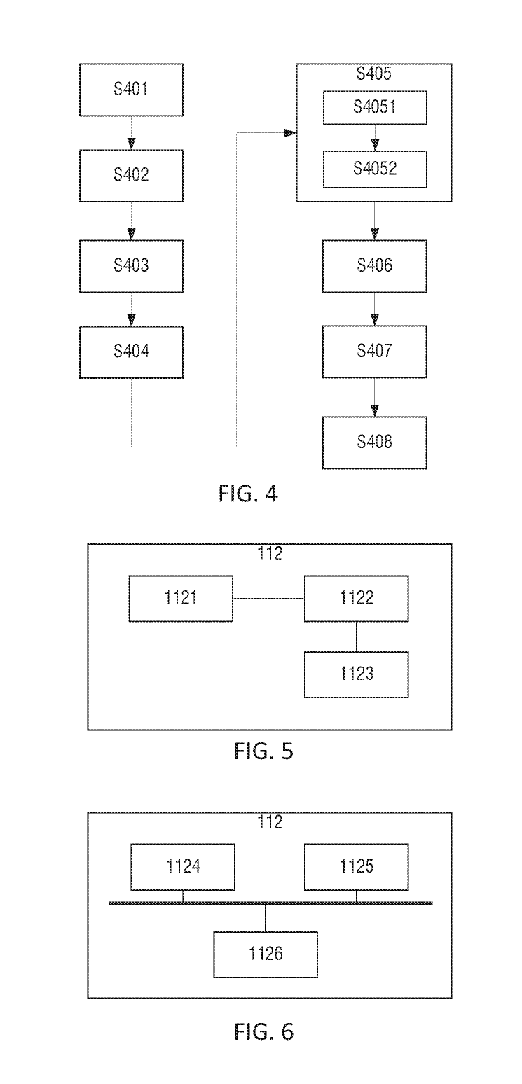

FIG. 4 is a flowchart of an OT monitoring method according to an embodiment of the present invention. As shown in FIG. 4, the method may include the following steps:

S401: A network sensor 111 captures at least one data packet 20 transmitted in an OT system 10.

As described above, the network sensor 111 may be deployed in different subnets of the OT system 10. A SPAN port is configured on a switch or a router in a subnet, or a network tap is deployed on a cable, so that the network sensor 111 can capture the data packet 20 from the OT system 10 by using a passive network monitoring manner. Optionally, the network sensor 111 captures all packets transmitted in the OT system 10.

S402: The network sensor 111 sends the captured data packet 20 to an OT monitoring apparatus 112.

The network sensor 111 may send the captured data packet 20 in a PCAP packet to the OT monitoring apparatus 112. To avoid affecting communication of the OT system 10, the network sensor 111 may send the captured data packet 20 by using a separate network interface. Optionally, the network sensor 111 may further have a local buffering function. When the network sensor 111 is disconnected from the OT monitoring apparatus 112, the network sensor 111 may store a particular quantity of data packets 20, and send the buffered data packets 20 after a connection is resumed.

S403: The OT monitoring apparatus 112 performs data cleansing for the captured data packet 20.

After obtaining the data packet 20 from the network sensor 111, the OT monitoring apparatus 112 may perform data cleansing first, which includes, but is not limited to, removing an irrelevant data packet 20, removing a redundant data packet 20, combining repeatedly sent data packets 20, and the like.

S404: The OT monitoring apparatus 112 marks an identifier of the network sensor 111 for the data packet 20.

S405: The OT monitoring apparatus 112 extracts information 30 from the data packet 20.

In this step, the data packet 20 that is cleansed and for which the identifier of the network sensor 111 is marked is analyzed to extract each asset 101 related to the OT system 10 and information 30 about a network. The information 30 may include: network information extracted from an Ethernet frame or an IT/TCP/TDP packet header, for example, a MAC address, an IP address, a TCP/UDP port number, and a TCP identifier.

In this step, a network connection relationship 302 of the assets in the OT system 10 may be further derived based on deployment of the network sensor 111. For example, data packets 20 from a same network sensor 111 may come from a same router or switch 1013, that is, come from a same subnet.

In this step, a network behavior of the OT system 10 may be further monitored based on knowledge of a network protocol. For example, when a TCP packet passes through a router, the router decreases a value of a TTL field by 1. Therefore, when the module monitors a phenomenon that the value of the TTL field is decreased by 1, it may be determined that the TCP packet passes through a router rather than a switch.

In this step, further derivation may be further performed based on basic knowledge of a network. For example, if assets 101 in a group all have a prefix such as 192.168.0.*, it may be determined that an address of a subnet to which the assets 101 in the group belong may be 192.168.0.0/24.

Optionally, step S405 may include the following sub-steps:

S4051: The OT monitoring apparatus 112 classifies the captured data packet 20 according to an industrial protocol, and classifies the data packet 20 into different sequences or groups.

S4052: The OT monitoring apparatus 112 performs DPA on the classified data packet 20. By way of the DPA, the information may be extracted from a data payload of the industrial protocol, and various extracted information may be further associated to obtain valuable information related to the OT system 10. The extracted information 30 may include, but is not limited to: information 301 about the asset in the OT system 10, where the information 301 may be directly extracted from, for example, a data payload of industrial information such as the LLDP or the PROFINET-DCP.

S406: The OT monitoring apparatus 112 stores the extracted information 30 in a database.

S407: The OT monitoring apparatus 112 provides the information 30 to an application 505 by using an API.

An implementation of the API includes, but is not limited to: a RESTful API, an XML-RPC API, or a JSON RPC API.

S408: The application invokes the API to implement a monitoring function and present a monitoring result.

The application 12 can implement the following monitoring function based on the information 30: 1) generation of an asset directory, 2) discovery of a network topology, 3) change monitoring, and 4) operation monitoring.

1) Generation of an Asset Directory

The extracted information 301 about the asset 101 is associated with a MAC address of the asset 101, so that the following features of the asset 101 may be obtained:

the MAC address;

an IP address bound with the MAC address, where for a switch 1013, one IP address may correspond to multiple MAC addresses;

a supplier, which may be obtained from the MAC address of the asset 101 because first 24 bits of the MAC address are used to identify the supplier;

an open port or service of the asset 101, which may be derived from a destination port number of the asset;

a type of the asset 101, which may be extracted from a specified field in the IP/TCP/UDP, for example, a TTL field in an IP packet, an ID field in the IP packet, a TCP window length, an option in TCP SYN and TCP SYN+ACK, and a field in a Dynamic Host Configuration Protocol (DHCP) packet, an Internet Control Message Protocol (ICMP) packet, or a Hypertext Transfer Protocol (HTTP) packet; and

information indicating whether the asset 101 exists, where, for example, when a TCP packet passes through a router, the router decreases a value of a TTL field by 1; therefore, when the module monitors a phenomenon that the value of the TTL field is decreased by 1, it may be determined that the TCP packet passes through a router rather than a switch.

In addition, a host name, a device type, a device identifier, a hardware version, a firmware version, and the like of the asset 101 may be further included, and may be obtained from a data payload of an industrial protocol such as the LLDP, the PROFINET-DCP, the S7Comm, or the OPC UA. It may be determined, according to the information, whether the asset 101 is a workstation, a server, an HMI, an industrial controller, or a switch or a router. Many assets 101 in the OT system broadcast attributes thereof, for example, a device name, an IP address, a device model, and a firmware version may be provided by using a specific packet of the LLDP or the PROFINET-DCP at an Ethernet layer. The OT monitoring apparatus 112 can identify the packets, and extract the foregoing information and record the information in the asset directory 401.

2) Discovery of the Network Topology

The network topology of the OT monitoring system 11 may be obtained by using the following method:

An asset 101 in a same switch or router to which a specific network sensor 111 is connected may be determined according to a data packet 20 from the specific network sensor 111. Generally, in an OT system 10, an industrial host is deployed at a management layer, another industrial controller such as a PLC is deployed at a control layer, and a switch or a router is located between the management layer and the control layer. A network connection relationship 302 of assets 101 may be further obtained, for example, assets belonging to a same subnet 100 are determined based on front parts of IP addresses of the assets 101. Optionally, a switch from which the data packet 20 comes and other assets 101 connected to the switch may be identified according to the network sensor 111 from which the data packet 20 comes. A form of (asset A, asset B) is used to record a connection between the assets, and all connections are stored in one set, to form the network topology 402 of the OT system 10. In addition, when the asset 101 in the OT system 10 changes, a set of a new connection may be generated, and a formation time and an end time of each set are recorded, so that a change in the network topology 402 of the OT system 10 can be traced back.

3) Change Monitoring

The OT system 10 is continuously monitored, and for example, a time of an asset 101 that newly appears and information about the asset, and expiration information of an old asset (for example, there is no activity in 72 hours) are recorded, so as to monitor a change in the OT system 10.

Generally, an OT system is a system of high certainty, and after the OT system is configured, a communication relationship of assets is fixed. Therefore, long-term monitoring may be performed on communication between the assets in the OT system 10 to identify the relationship of the assets 101, and an abnormality that violates the relationship may be further identified.

4) Operation Monitoring

A control variable and a value thereof of the asset 101 may be obtained by performing DPA on a data payload of a specific industrial protocol. Therefore, the operation for the OT system 10 may be determined based on the extracted operation information for the asset in the OT system 10. Further, predictive maintenance and a diagnostic analysis may be performed.

The asset directory 401 and the network topology 402 of the OT system 10, the relationship 4031 of the assets, the system change 4032, and the operation for the OT system 10 may be obtained by running the foregoing application. The obtained information may be further displayed, and a display manner includes, but is not limited to:

displaying information about an asset 101 in the asset directory 401 in a form of a list.

The network topology 402 of the OT system 10 is presented in the following layout:

displaying the industrial host 1012 at the top of a screen;

displaying the industrial controller 1011 at the bottom of the screen; and

displaying the router or switch 1013 at the center of the screen, to connect to the industrial host 1012 and the industrial controller 1011.

An evolution process of the network topology 402 of the OT system 10 is displayed. Optionally, a change in the network topology 402 may be marked at a specific time point. A user may select different time points on the screen, and correspondingly, a network topology 402 at the selected time point and a change occurring at the time point are presented. Optionally, the user may add information to the asset directory 401, for example, an asset owner, or a geographical position of an asset.

FIG. 5 is a schematic structural diagram of an OT monitoring apparatus 112 according to an embodiment of the present invention. As shown in FIG. 5, the apparatus 112 may include:

a data obtaining module 1121, configured to obtain at least one data packet 20 transmitted in an OT system 10;

an information extraction module 1122, configured to extract, from the at least one data packet 20 obtained by the data obtaining module 1121, information 301 about at least one asset 101 included in the OT system 10; and

a monitoring module 1123, configured to determine an asset directory 401 of the OT system 10 according to the information 301 about the at least one asset 101 extracted by the information extraction module 1122.

Optionally, the information extraction module 1122 is specifically configured to extract network information of the at least one asset 101 from a transport layer header of the obtained at least one data packet 20; and the monitoring module 1123 is specifically configured to determine that the asset directory 401 includes the network information of the at least one asset 101.

Optionally, the information extraction module 1122 is specifically configured to: classify the obtained at least one data packet 20 according to an industrial protocol; and for each industrial protocol used for classification, extract asset description information of an involved asset 101 from a data payload of the industrial protocol in a data packet 20 using the industrial protocol; and the monitoring module 1123 is specifically configured to determine that the asset directory 401 includes asset description information of the at least one asset 101.

Optionally, the information extraction module 1122 is further configured to determine, according to the at least one data packet 20 obtained by the data obtaining module 1121, a network connection relationship 302 of the at least one asset 101 included in the OT system 10; and the monitoring module 1123 is further configured to determine a network topology 402 of the OT system 10 according to the determined network connection relationship 302 of the at least one asset 101. Further, the data obtaining module 1121 is specifically configured to: for each of at least one subnet 100 of the OT system 10, obtain a data packet 20 in the subnet 100; the information extraction module 1122 is specifically configured to determine, according to the data packet 20 obtained from each of the at least one subnet 100, an asset 101 included in the subnet 100; and the monitoring module 1123 is specifically configured to determine that the network topology 402 of the OT system 10 includes information about the at least one subnet 100.

Optionally, there is a plurality of assets 101, the information extraction module 1122 is further configured to obtain communication information 303 of the at least one asset 101 from the obtained at least one data packet 20; the monitoring module 1123 is further configured to determine an asset feature 4031 of the at least one asset 101 according to the communication information 303 of the at least one asset 101 determined by the information extraction module 1122 (where the asset feature 4031 may be a logical relationship of the at least one asset 101). Further, the monitoring module 1123 is further configured to determine a change 4032 in the asset feature 4031 of the at least one asset 101 in the OT system 10 according to the communication information 303 of the at least one asset 101 determined by the information extraction module 1122 (the change 1032 may be a change that violates the determined logical relationship of the at least one asset 101).

Optionally, the information extraction module 1122 is specifically configured to: classify the obtained at least one data packet 20 according to an industrial protocol; and for each industrial protocol used for classification, extract operation information 304 of an involved asset 101 from a data payload of the industrial protocol in a data packet 20 using the industrial protocol; and the monitoring module 1123 is further configured to determine an operation 404 for the OT system 10 according to the operation information 304 extracted by the information extraction module 1122.

In an optional solution of the OT monitoring apparatus 112, the monitoring module 1123 implements a function of a monitoring application, for example, generating the asset directory and the network topology, and determining the asset feature of the asset, the change in the asset feature, and the operation for the OT system. In another optional implementation, the monitoring module 1123 provides an API externally, to be invoked by an application to implement one or more functions of the foregoing monitoring application. Specifically, the OT monitoring apparatus 112 may include:

a data obtaining module 1121, configured to obtain at least one data packet 20 transmitted in an OT system 10;

an information extraction module 1122, configured to extract, from the at least one data packet 20 obtained by the data obtaining module 1121, information 301 about at least one asset 101 included in the OT system 10; and

a monitoring module 1123, configured to provide a first API according to the information 301 about the at least one asset 101 extracted by the information extraction module 1122, where the first API is configured to be invoked to generate an asset directory 401 of the OT system 10.

Optionally, the information extraction module 1122 is specifically configured to extract network information of the at least one asset 101 from a transport layer header of the obtained at least one data packet 20; and the monitoring module 1123 is specifically configured to provide the first API 101, so that when the first API is invoked, information 30 about the asset 101 in the generated asset directory 401 of the OT system 10 includes the network information of the asset 101.

Optionally, the information extraction module 1122 is specifically configured to: classify, according to an industrial protocol, the at least one data packet 20 obtained by the data obtaining module 1121; and for each industrial protocol used for classification, extract asset description information of an involved asset 101 from a data payload of the industrial protocol in a data packet 20 using the industrial protocol; and the monitoring module 1123 is specifically configured to provide the first API, so that when the first API is invoked, information 30 about the asset 101 in the generated asset directory 401 of the OT system 10 includes asset description information of the asset 101.

Optionally, the information extraction module 1122 is further configured to determine, according to the obtained at least one data packet 20, a network connection relationship 302 of the at least one asset 101 included in the OT system 10; and the monitoring module 1123 is further configured to provide a second API according to the network connection relationship 302 of the at least one asset 101 determined by the information extraction module 1122, where the second API is configured to be invoked to generate a network topology 402 of the OT system 10.

Optionally, the data obtaining module 1121 is specifically configured to: for each of at least one subnet 100 of the OT system 10, obtain a data packet 20 in the subnet 100; the information extraction module 1122 is specifically configured to determine, according to the data packet 20 obtained from each of the at least one subnet 100, an asset 101 included in the subnet 100; and the monitoring module 1123 is specifically configured to provide the second API, so that when the second API is invoked, the generated network topology 402 of the OT system 10 includes information about the at least one subnet 100.

Optionally, there is a plurality of assets 101, and the information extraction module 1122 is further configured to extract communication information 303 of the at least one asset 101 from the at least one data packet 20 obtained by the data obtaining module 1121; the monitoring module 1123 is further configured to provide a third API according to the communication information 303 of the at least one asset 101 determined by the information extraction module 1122, where the third API is configured to be invoked to determine an asset feature 4031 of the at least one asset 101 in the OT system 10. Further, the monitoring module 1123 is further configured to provide the third API, where the third API is configured to be invoked to determine a change 4032 that the OT system 10 violates the determined asset feature 4031 of the at least one asset 101.

Optionally, the information extraction module 1122 is specifically configured to: classify, according to an industrial protocol, the at least one data packet 20 obtained by the data obtaining module 1121; and for each industrial protocol used for classification, extract operation information 304 for an involved asset 101 from a data payload of the industrial protocol in a data packet 20 using the industrial protocol; and the monitoring module 1123 is further configured to provide a fourth API according to the operation information 304 extracted by the information extraction module 1122, where the fourth API is configured to be invoked to determine an operation 404 for the OT system 10.

FIG. 6 is another schematic structural diagram of an OT monitoring apparatus 112 according to an embodiment of the present invention. In the structure, the OT monitoring apparatus 112 includes at least one memory 1124, configured to store machine readable instructions; and at least one processor 1125, configured to invoke the machine readable instructions stored in the at least one memory 1124, to perform the method performed by the OT monitoring apparatus 112 in the embodiments of the present invention. Optionally, the structure may further include a display 1126, configured to display a result of monitoring an OT system 10 by the OT monitoring apparatus 112, for example, an asset directory, a network topology, a change in a relationship of assets, and an operation for the OT system 10. The at least one processor 1125, the at least one memory 1124, and the display 1126 may be connected by using a bus.

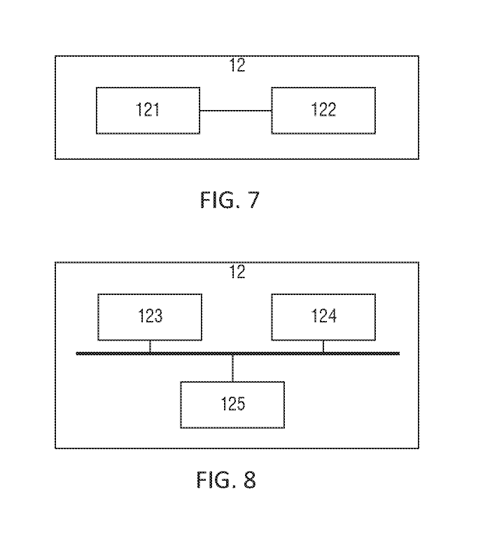

FIG. 7 is a schematic structural diagram of an OT monitoring application apparatus 12 according to an embodiment of the present invention. In the structure, the OT monitoring application apparatus 12 may include: an API invoking module 121, configured to invoke at least one API 504; and an application implementation module 122, configured to invoke the at least one API 504 to implement at least one of the following monitoring items on an OT system 10: generating an asset directory 401 of the OT system 10; determining a network topology 402 of the OT system 10; determining an asset feature 4031 of at least one asset 101 in the OT system 10; determining a change 4032 in the asset feature 4031 of the at least one asset 101 in the OT system 10; and determining an operation 404 for the OT system 10.

FIG. 8 is another schematic structural diagram of an OT monitoring application apparatus 12 according to an embodiment of the present invention. In the structure, the OT monitoring application apparatus 12 includes at least one memory 123, configured to store machine readable instructions; and at least one processor 124, configured to invoke the machine readable instructions stored in the at least one memory 123, to perform the method performed by the OT monitoring application apparatus 12 in the embodiments of the present invention. Optionally, the structure may further include a display 125, configured to display a monitoring result of an OT system 10, for example, an asset directory, a network topology, a change in an asset feature, and an operation for the OT system 10. The at least one processor 124, the at least one memory 123, and the display 125 may be connected by using a bus.

An embodiment of the present invention further provides a storage medium. The storage medium may store machine readable instructions. When the machine readable instructions are invoked by a processor, the OT monitoring method provided in the embodiments of the present invention can be performed. The storage medium may be a floppy disk, a hard disk, a memory, a magneto-optical disk, an optical disk, a magnetic tape, or a non-volatile storage card. The storage medium may also be a storage resource on a remote server (for example, an application server, and the remote server may be deployed on cloud), and the OT monitoring apparatus 112 provided in the embodiments of the present invention may download the machine readable instructions from the remote server, and runs the machine readable instructions on a local device, or the machine readable instructions may be run in a form of a microservice.

It should be noted that, steps and modules in the foregoing procedures and various system structural diagrams are not all necessary, and some steps or modules may be ignored according to an actual requirement. An execution order of the steps is not fixed, and may be adjusted as required. System structures described in the foregoing embodiments may be physical structures or may be logical structures, that is, some modules may be implemented by using a same physical entity or some modules may be implemented by using multiple physical entities or may be jointly implemented by some components in multiple independent devices.

In the foregoing embodiments, hardware units may be implemented mechanically or electrically. For example, a hardware unit may include a permanent dedicated circuit or logic (for example, a dedicated process, an FPGA, or an ASIC) to complete corresponding operations. The hardware unit may further include programmable logic or a programmable circuit (for example, a general-purpose processor or another programmable processor), and corresponding operations may be completed by using software that is temporarily set. A specific implementation (a mechanical manner, a dedicated persistent circuit, or a circuit that is temporarily set) may be determined by considering costs and a time.

The present invention is presented and described in detail above by using the accompanying drawings and the preferred embodiments; however, the present invention is not limited to the disclosed embodiments. Based on the foregoing multiple embodiments, a person skilled in the art may know that, more embodiments of the present invention can be obtained by combining code review operations in the foregoing different embodiments, and these embodiments should also fall within the protection scope of the present invention.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An operational technology monitoring apparatus, comprising:
at least one memory, configured to store machine readable instructions; and
at least one processor, configured to invoke the machine readable instructions, stored in the at least one memory, to perform at least:
obtaining at least one data packet transmitted in an OT system;
extracting, from the at least one data packet obtained, information about at least one asset included in the OT system; and
determining an asset directory of the OT system according to the information about the at least one asset extracted.

2. The apparatus of claim 1, wherein the at least one processor is further configured to invoke the machine readable instructions, stored in the at least one memory, to perform at least
extracting network information of the at least one asset from a transport layer header of the at least one data packet obtained, when extracting, from the at least one data packet obtained, information about at least one asset included in the OT system; and
determining that the asset directory includes the network information of the at least one asset, when determining the asset directory of the OT system according to the information about the at least one asset extracted.

3. The apparatus of claim 1, wherein the at least one processor is further configured to invoke the machine readable instructions, stored in the at least one memory, to perform at least
classifying the at least one data packet obtained according to an industrial protocol;
extracting, for each industrial protocol used for classification, asset description information of an involved asset from a data payload of the industrial protocol in a data packet using the industrial protocol, when extracting, from the at least one data packet obtained, information about at least one asset included in the OT system; and
determining that the asset directory includes asset description information of the at least one asset, when determining an asset directory of the OT system according to the information about the at least one asset extracted.

4. The apparatus of claim 1, wherein the at least one processor is further configured to invoke the machine readable instructions, stored in the at least one memory, to, after the obtaining of the at least one data packet transmitted in an OT system, perform at least:
determining, according to the at least one data packet obtained, a network connection relationship of the at least one asset included in the OT system; and
determining a network topology of the OT system according to the network connection relationship of the at least one asset determined.

5. The apparatus of claim 4, wherein the at least one processor is further configured to invoke the machine readable instructions, stored in the at least one memory, to perform at least
obtaining, for each of at least one subnet of the OT system, a data packet in the respective at least subnet, when obtaining at least one data packet transmitted in an OT system;
determining, according to the data packet obtained from each of the at least one subnet, an asset included in the subnet, when determining, according to the at least one data packet obtained, a network connection relationship of the at least one asset included in the OT system; and
determining that network topology of the OT system includes information about the at least one subnet, when determining a network topology of the OT system according to the network connection relationship of the at least one asset determined.

6. The apparatus of claim 1, wherein there is a plurality of assets, and wherein the at least one processor is further configured to invoke the machine readable instructions, stored in the at least one memory, to perform at least:
extracting communication information of the at least one asset from the at least one data packet obtained; and
determining at least one of
an asset feature of the at least one asset according to the communication information of the at least one asset determined, and
a change in an asset feature of the at least one asset in the OT system according to the communication information of the at least one asset determined.

7. The apparatus of claim 1, wherein the at least one processor is further configured to invoke the machine readable instructions, stored in the at least one memory, to perform at least:
classifying the at least one data packet obtained according to an industrial protocol, and for each industrial protocol used for classification, extracting operation information for an involved asset from a data payload of the industrial protocol in a data packet using the industrial protocol, when extracting, from the at least one data packet obtained, information about at least one asset included in the OT system; and
determining an operation for the OT system according to the operation information extracted.

8. An operational technology monitoring apparatus, comprising:
at least one memory, configured to store machine readable instructions; and
at least one processor, configured to invoke the machine readable instructions stored in the at least one memory, to perform at least:
obtaining at least one data packet transmitted in an OT system;
extracting, from the at least one data packet obtained, information about at least one asset included in the OT system; and
providing a first application programming interface (API) according to the information about the at least one asset extracted, wherein the first API is configured to be invoked to generate an asset directory of the OT system.

9. The apparatus of claim 8, wherein the at least one processor is furthered configured to invoke the machine readable instructions stored in the at least one memory, to perform at least:
extracting network information of the at least one asset from a transport layer header of the at least one data packet obtained, when extracting, from the at least one data packet obtained, information about at least one asset included in the OT system; and
providing the first API, so that when the first API is invoked, information about an asset in the asset directory of the OT system generated includes network information of the asset, when providing a first API according to the information about the at least one asset extracted.

10. The apparatus of claim 8, wherein the at least one processor is furthered configured to invoke the machine readable instructions stored in the at least one memory, to perform at least:
classifying the at least one data packet obtained according to an industrial protocol;
extracting, for each industrial protocol used for the classifying, asset description information of an involved asset from a data payload of the industrial protocol in a data packet using the industrial protocol, when extracting, from the at least one data packet obtained, information about at least one asset included in the OT system; and
providing the first API, so that when the first API is invoked, information about an asset, in the asset directory of the OT system generated, includes asset description information of the asset, when providing a first API according to the information about the at least one asset extracted.

11. The apparatus of claim 8, wherein the at least one processor is further configured to invoke the machine readable instructions stored in the at least one memory, to perform after the obtaining of the at least one data packet transmitted in an OT system, at least:
determining, according to the at least one data packet obtained, a network connection relationship of the at least one asset included in the OT system; and
providing a second API according to the network connection relationship of the at least one asset determined, wherein the second API is configured to be invoked to generate a network topology of the OT system.

12. The apparatus of claim 11, wherein the at least one processor is further configured to invoke the machine readable instructions stored in the at least one memory, to perform at least:
obtaining, for each of at least one subnet of the OT system, a data packet in the respective at least one subnet, when obtaining the at least one data packet transmitted in an OT system;
determining, according to the data packet obtained from each of the at least one subnet, an asset included in the subnet, when determining, according to the at least one data packet obtained, a network connection relationship of the at least one asset included in the OT system; and
providing the second API, so that when the second API is invoked, the network topology of the OT system generated includes information about the at least one subnet, when providing a second API according to the network connection relationship of the at least one asset determined.

13. The apparatus of claim 8, wherein the at least one asset includes a plurality of assets, and wherein the at least one processor is further configured to invoke the machine readable instructions stored in the at least one memory, to perform at least:
extracting communication information of the plurality of assets from the at least one data packet obtained; and
providing a third API according to the communication information of the plurality of assets determined, wherein the third API is configured to be invoked to determine at least one of:
an asset feature of the plurality of assets in the OT system, and
a change in an asset feature of at least one asset of the plurality of assets in the OT system.

14. The apparatus of claim 8, wherein the at least one processor is further configured to invoke the machine readable instructions stored in the at least one memory, to perform at least:
classifying the at least one data packet obtained according to an industrial protocol, and for each industrial protocol used for classification, extract operation information for an involved asset from a data payload of the industrial protocol in a data packet, using the industrial protocol, when extracting, from the at least one data packet obtained, information about at least one asset included in the OT system; and
providing a fourth API according to the operation information extracted, wherein the fourth API is configured to be invoked to determine an operation for the OT system.

15. A machine readable medium, storing machine readable instructions, wherein when the machine readable instructions are invoked by at least one processor, following steps are performed:
obtaining at least one data packet transmitted in an OT system;
extracting, from the at least one data packet obtained, information about at least one asset included in the OT system; and
determining an asset directory of the OT system according to the information about the at least one asset extracted, or providing a first application programming interface (API) according to the information about the at least one asset extracted, wherein the first API is configured to be invoked to generate an asset directory of the OT system.
